(19) United States
(12) Patent Application Publication
(10) Pub. No.: US 2020/0015471 A1
(43) Pub. Date: Jan. 16, 2020

(54) INSECT EXTERMINATION DEVICE

(71) Applicant: Advanced Thermal Control, Inc., Gleln Rock, PA (US)

(72) Inventor: Bryan Guderjohn, Glen Rock, PA (US)

(73) Assignee: Advanced Thermal Control, Inc., Glen Rock, PA (US)

(21) Appl. No.: 16/033,364

(22) Filed: Jul. 12, 2018

(51) Int. Cl. A01M 3/00; F24H 3/04

(52) U.S. Cl. CPC A01M 3/007; F24H 3/0405

(57) ABSTRACT

An insect extermination device that draws air from outside an exterminator housing into the exterminator housing through an air inlet, heats the air, and forces the heated air out of the exterminator housing through an air outlet.

### FIELD OF THE INVENTION

The present invention relates, in general, to insect extermination and, in particular, to equipment that exterminates insects, such as bed bugs.

### BACKGROUND

There is no need to go into great detail about the problem of the presence of insects in our homes, workplaces, and other locations. The very many extermination services and the many pieces of equipment that are available for purchase provide clear proof that insects are a serious, major problem.

Unfortunately, many of the insect extermination devices that are currently available, for the most part, have one or more of the following shortcomings: very expensive, large and heavy and therefore cumbersome, and require a very high level of electricity to operate. Moreover, there are no insect extermination devices available for purchase by consumers that are reasonable in price and of a size that they can to be moved easily to the area to be exterminated and handled easily while conducting the extermination effectively.

### SUMMARY

An insect extermination device, constructed in accordance with the present invention, includes an exterminator housing, a heater, and a pump. The exterminator housing has an air inlet and an air outlet. The pump, within the exterminator housing, is powered to draw air from outside the exterminator housing into the exterminator housing through the air inlet and force air drawn from outside the exterminator housing through the heater to exit heated air from the exterminator housing through the air outlet.

### BRIEF DESCRIPTION OF THE DRAWINGS

FIG. 1 is a front perspective view of an insect extermination device constructed in accordance with the present invention.

FIG. 2 is a front view of the FIG. 1 insect extermination device.

FIG. 3 is a rear perspective view of the FIG. 1 insect extermination device.

FIG. 4 is a side view of the FIG. 1 insect extermination device.

FIG. 5 is an exploded perspective view of the FIG. 1 insect extermination device.

FIG. 6 is a sectional view of the FIG. 1 insect extermination device taken along line 6-6 of FIG. 2.

FIG. 7 is a sectional view of the FIG. 1 insect extermination device taken along line 7-7 of FIG. 2.

FIG. 8 is a perspective view of the FIG. 1 insect extermination device in use to exterminate bed bugs from a bed.

### DETAILED DESCRIPTION OF THE EMBODIMENT(S)

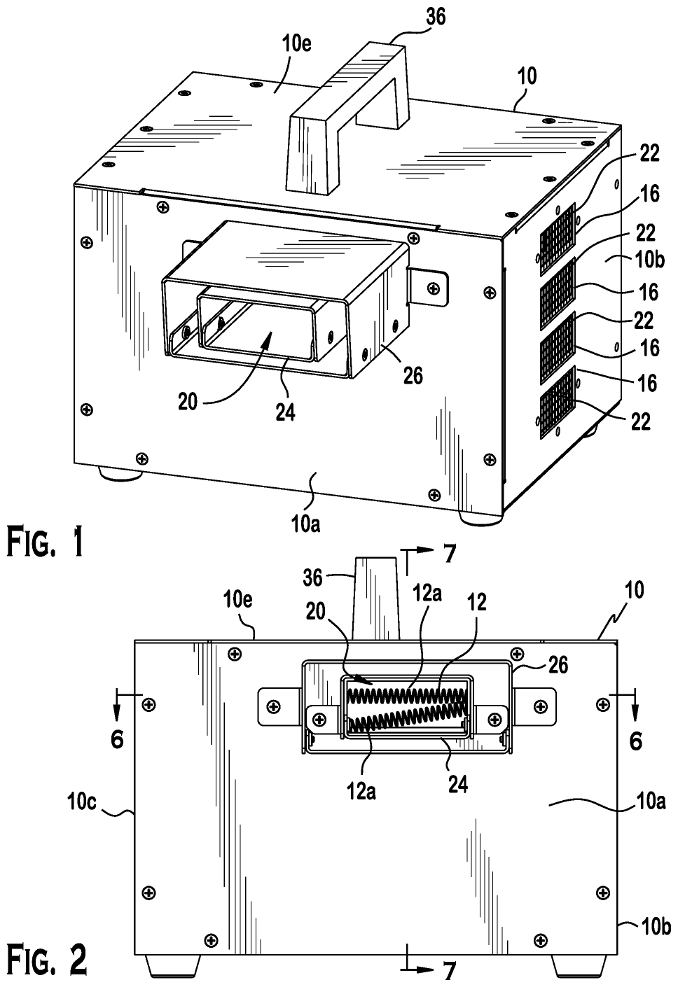

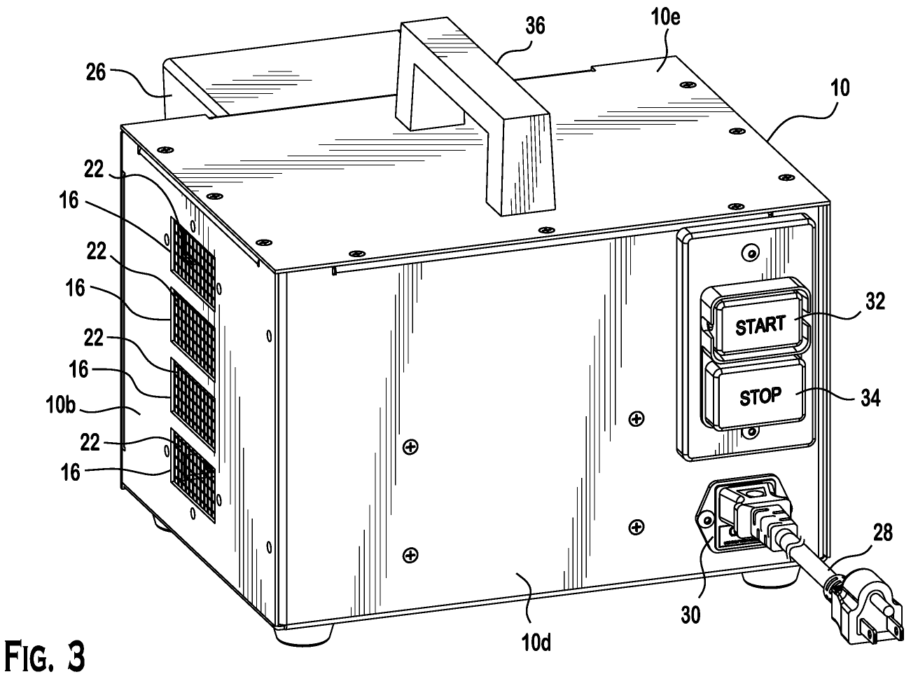

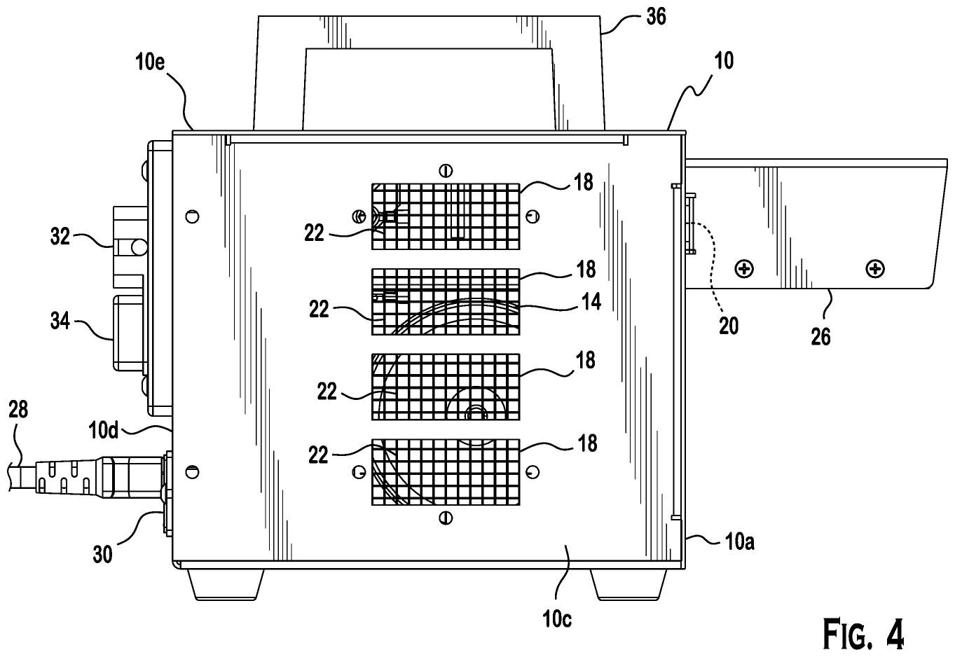

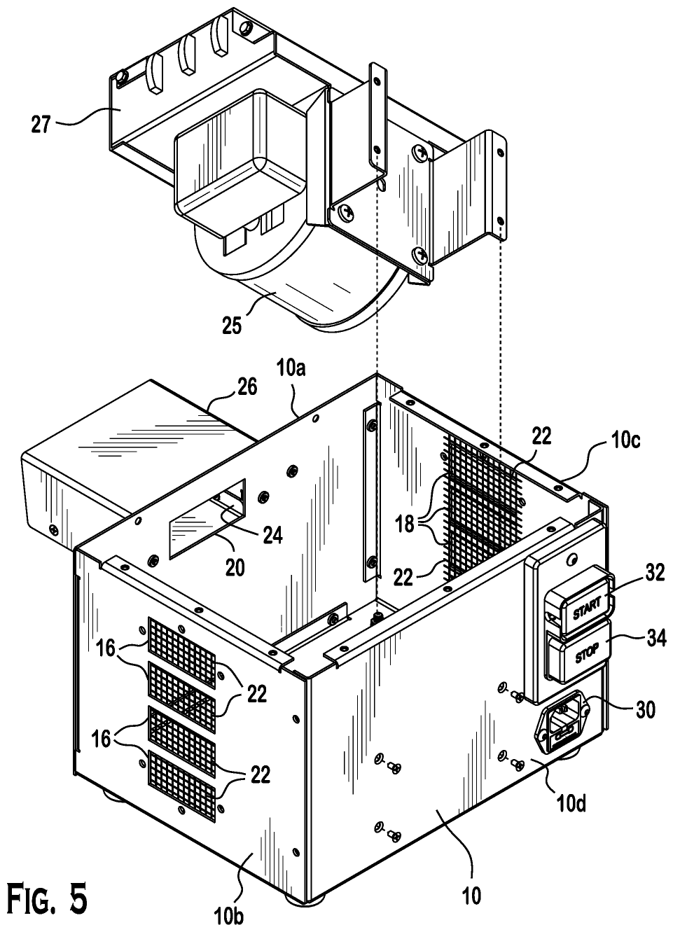

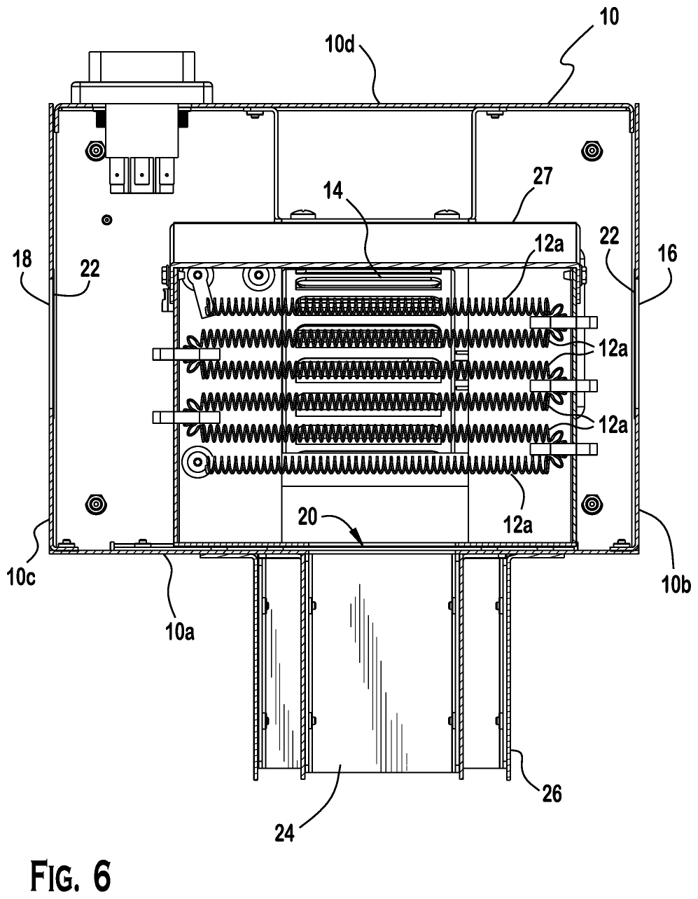

Referring to FIGS. 1 through 4, an insect extermination device, constructed in accordance with the present invention, includes an exterminator housing 10, a heater 12 within the exterminator housing 10, and a pump 14 within the exterminator housing 10. For the embodiment of the present invention illustrated and being described, exterminator the housing 10 has a rectangular, horizontal cross-section with a front wall 10a, a first side wall 10b, a second side wall 10c, and a back wall 10d that form an air retention space 11.

For the particular exemplary construction of exterminator housing 10 illustrated and being described, the side wall 10b of the exterminator housing 10 includes first air inlet openings 16 extending there through. Likewise, the exterminator housing 10 further includes second air inlet openings 18 positioned along the side wall 10d and extending there through. In an exemplary embodiment of the invention, the second air inlet openings 18 correspond in position, shape and size with the first air inlet openings 16.

As shown, the front wall 10a includes an air outlet 20 extending there through . The number, sizes, and positions of the first air inlet openings 16 and the second air inlet openings 18 is dependent on the application of the insect extermination device. When an insect extermination device, constructed in accordance with the present invention, is to be used in exterminating bed bugs, the ratio of the total cross-sectional area of air inlets 16 and 18 to the total cross-sectional area of air outlet 20 is preferably approximately 6.4:1.

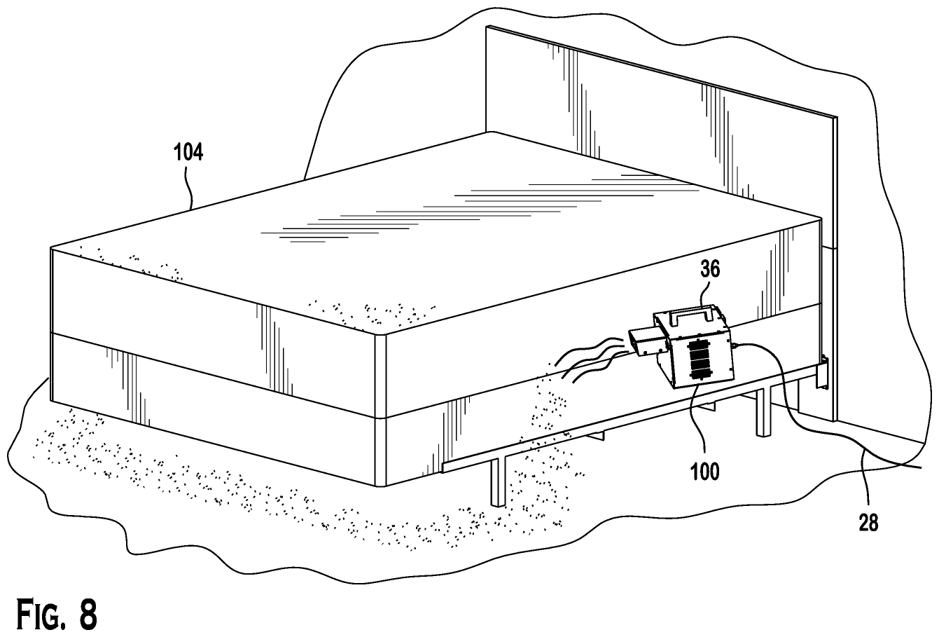

The pump 14, shown in greater detail in FIG. 7, is powered to draw air from outside exterminator housing 10 into the exterminator housing 10 through the air inlets 16, 18 and force air, drawn from outside the exterminator housing 10, through the heater 12 that is mounted in proximity to the air outlet 20 to exit heated air from the exterminator housing 10 through the air outlet 20. A plurality of screens 22, individually covering each air inlet 16, 18, are provided and positioned to catch debris particles in the air being drawn into exterminator housing 10.

The relationship between air flow and temperature for an insect extermination device constructed in accordance with the present invention is dictated by the particular use of the insect extermination device. A relationship between air flow and temperature of approximately 65-75 cubic feet per minute and a set temperature of 150-170 degrees F. has been found to be especially effective in ridding an area infested with bed bugs.

More particularly, a relationship between air flow and temperature of approximately 70 cubic feet per minute and a set temperature of 160 degrees F. has been found to be especially effective in ridding an area infested with bed bugs.

For the embodiment of the present invention illustrated and being described, the insect extermination device further includes a sleeve 24 fixed to the front wall 10a of the exterminator housing 10 and aligned to correspond with the air outlet 20. The sleeve 24 serves to concentrate heated air exiting through the air outlet 20 from the exterminator housing 10. An insulation 26 surrounding the sleeve 24, through which heated air exits from exterminator housing 10, serves to protect the user of the insect extermination device from being burned.

As shown most clearly in FIG. 7, a shroud 25 surrounds pump 14. Air from outside exterminator housing 10 is drawn into shroud 25 by pump 14 and passes to heater 12.

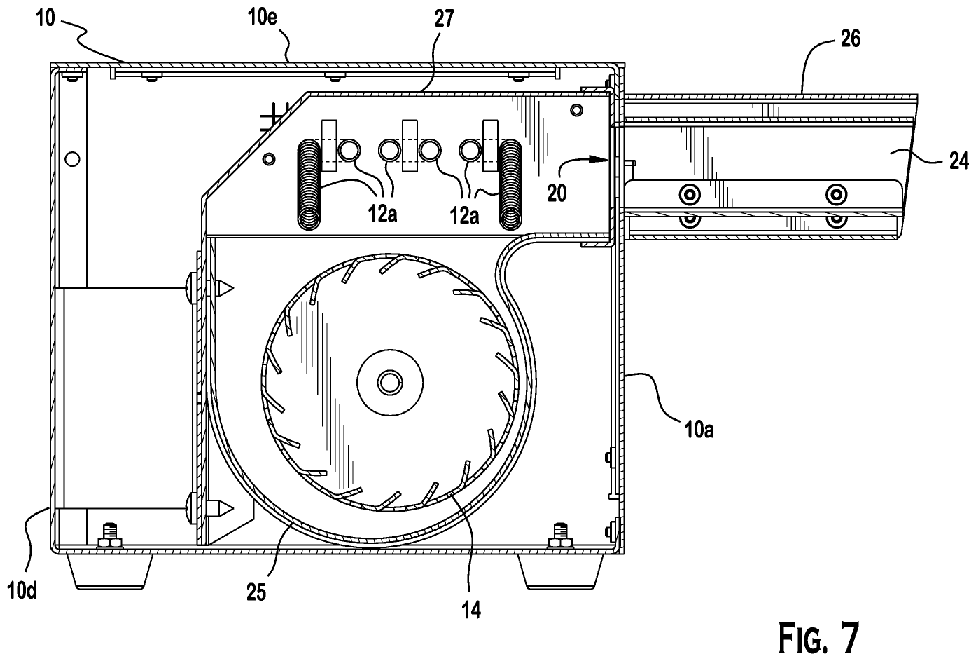

For the embodiment present invention illustrated and being described, the insect extermination device further includes a heater housing 27 in which heater 12 contained. Air drawn through the air inlets 16 and 18 into exterminator housing 10 by the pump 14 is forced to leave the shroud 25 and enter heater housing 27, also shown in FIGS. 6 and 7.

For the embodiment of the present invention illustrated and being described, the heater 12 is a three-dimensional array of series-connected conductor coils 12a, shown most clearly in FIG. 6, and positioned in proximity to air outlet 20. More particularly, the three-dimensional array of series-connected conductor coils 12a are positioned along a common plane that runs through the air outlet 20. The nature of this construction of heater 12 enhances the efficiency of heating the air drawn from outside exterminator housing 10 and conducting regulated heated air through the air outlet 20 and directed to an area of extermination.

The heater 12 and pump 14 are powered by a power line cord 28 plugged into a receptacle 30 mounted on back wall 10d exterminator housing 10 and electrically connected to the pump 14 and to the heater 12. The insect extermination device is turned on or off by pressing a START button 32 or a STOP button 34.

The insect extermination device has a handle 36 secured to a top wall 10e of the insect extermination device to facilitate carrying the insect extermination device to and around the area to be exterminated.

Referring to FIG. 8, a handheld insect extermination device 100, constructed in accordance with the present invention, can be held by gripping handle 36 and carried to and moved easily around a bed 104 to rid the bed of bed bugs.

The foregoing describes some of the possibilities for practicing the present invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An insect extermination device comprising:
an exterminator housing having an air inlet and an air outlet;
a heater; and
a pump within the exterminator housing powered to:
(a) draw air from outside the exterminator housing into the exterminator housing through the air inlet, and
(b) force air drawn from outside the exterminator housing through the heater to exit heated air from the exterminator housing through the air outlet.

2. An insect extermination device according to claim 1, wherein:
(a) the exterminator housing has a plurality of walls forming an air retention space,
(b) the air inlet of the exterminator housing is a plurality of openings in a first wall of the exterminator housing, and
(c) the air outlet of the exterminator housing is a single opening in a second wall of the exterminator housing.

3. An insect extermination device according to claim 2, wherein a third wall of the exterminator housing has a second plurality of openings through which air from outside the exterminator housing is drawn into the air retention space.

4. An insect extermination device according to claim 3, further including a plurality of screens individually covering each of the openings in the first wall of the exterminator housing and the openings in the third wall of the exterminator housing.

5. An insect extermination device according to claim 4, further including a sleeve fixed to the second wall of the exterminator housing and aligned with the air outlet.

6. An insect extermination device according to claim 5, further including an insulation surrounding the sleeve.

7. An insect extermination device according to claim 4, further including a heater housing:
(a) within the exterminator housing,
(b) containing the heater, and
(c) into which air drawn through the openings in the first wall of the exterminator housing and the openings in the third wall of the exterminator housing enters and from which heated air exits through the air outlet.

8. An insect extermination device according to claim 7, wherein the heater is a three-dimensional array of series-connected conductor coils that are in proximity to the air outlet.

9. An insect extermination device according to claim 8, further including a shroud surrounding the pump and into which air drawn from outside the exterminator housing passes and from which air drawn from outside the exterminator housing passes to the heater housing.

10. An insect extermination device according to claim 9, further including a receptacle electrically connected to the pump and to the heater and adapted to receive an electrical power cord.

11. An insect extermination device according to claim 1, wherein the ratio of the total cross-sectional area of the air inlet to the total cross-sectional area of the air outlet is approximately 6.4:1.

12. An insect extermination device according to claim 10, wherein the ratio of the total cross-sectional area of the air inlet to the total cross-sectional area of the air outlet is approximately 6.4:1.

13. An insect extermination device comprising:
an exterminator housing having:
(a) a first side wall having a first air inlet,
(b) a front wall having an air outlet,
(c) a second side wall having a second air inlet;
a three-dimensional array of series-connected heating coils in the exterminator housing in proximity to the air outlet; and
a pump within the exterminator housing powered to:
(a) draw air from outside the exterminator housing into the exterminator housing through the air inlets in the first side wall and the third side wall, and
(b) force air drawn from outside the exterminator housing past the three-dimensional array of series-connected heating coils to exit heated air through the air outlet.

14. An insect extermination device according to claim 13, wherein:
(a) the air inlet in the first side wall is a first plurality of openings,
(b) the air inlet in the second side wall is a second plurality of openings, and
(c) the air outlet in the front wall is a single opening.

15. An insect extermination device according to claim 14, wherein the ratio of the total cross-sectional area of the first plurality of openings in the first side wall and the second plurality of openings in the second wall to the total cross-sectional area of the air outlet is approximately 6.4:1.

16. An insect extermination device according to claim 6:
(a) further including a handle, and
(b) wherein the exterminator housing has a top wall to which the handle is secured.

17. An insect extermination device according to claim 14:
(a) further including a handle, and
(b) wherein the exterminator housing has a top wall to which the handle is secured.
